(19) United States
(12) Patent Application Publication
(10) Pub. No.: US 2024/0304880 A1
(43) Pub. Date: Sep. 12, 2024

(54) SYSTEM AND METHOD FOR A BATTERY CELL WITH COMBINED STIFFENING AND GAS EXTRACTION

(71) Applicant: GM GLOBAL TECHNOLOGY OPERATIONS LLC, Detroit, MI (US)

(72) Inventors: Meng Jiang, Rochester Hills, MI (US); Louis G. Hector, JR., Shelby Twp, MI (US); Erik B. Golm, Sterling Heights, MI (US)

(73) Assignee: GM GLOBAL TECHNOLOGY OPERATIONS LLC, Detroit, MI (US)

(21) Appl. No.: 18/179,414

(22) Filed: Mar. 7, 2023

(51) Int. Cl. H01M 10/52; H01M 50/103; H01M 50/105; H01M 50/107; H01M 50/109; H01M 50/30; H01M 50/474; H01M 50/477; H01M 50/483; H01M 50/486

(52) U.S. Cl. CPC H01M 10/52; H01M 50/103; H01M 50/105; H01M 50/107; H01M 50/109; H01M 50/394; H01M 50/474; H01M 50/477; H01M 50/483; H01M 50/486; H01M 2220/20

(57) ABSTRACT

A battery cell includes an electrode stack including a pair of an anode and a cathode and a separator. Operation of the battery cell causes gas or moisture to form. The battery cell further includes a stiff frame. The frame includes a hollow portion. The electrode stack is disposed within the hollow portion. The frame includes a portion of the frame that is porous or includes a gas diffusion membrane. The battery cell further includes an electrolyte disposed within the frame and in contact with the electrode stack and a functional material disposed within the battery cell and outside of the hollow portion. The functional material absorbs the gas/moisture. The portion of the frame that is porous or includes a gas diffusion membrane enables the gas/moisture to exit the hollow portion and come into contact with the functional material while maintaining the electrolyte within the frame.

### INTRODUCTION

The present disclosure relates to a system and method for a battery cell with combined stiffening and gas extraction.

Lithium-ion batteries and lithium metal batteries are desirable candidates for powering electronic devices in the consumer, automotive, and aerospace industries due to their relatively high energy density, high power density, lack of memory effect, and long cycle life, as compared to other rechargeable battery technologies, including lead-acid batteries, nickel-cadmium and nickel-metal-hydride batteries.

Battery cells are produced in different configurations. Pouch battery cells may be flat, thin battery cells encased in a flexible pouch and may be useful to stack a plurality of the pouch battery cells in a relatively small package space. Prismatic can battery cells may be encased in a stiff, protective case. Cylindrical can battery cells are generally cylindrical and may be encased within a stiff cylindrical-shape case. Coin battery cells are similar to cylindrical can battery cells, with a low aspect ratio of height to diameter.

### SUMMARY

A battery cell is provided. The battery cell includes an electrode stack including at least one pair of an anode and a cathode and a separator disposed between the anode and the cathode. Operation of the battery cell causes gas or moisture to form. The battery cell further includes a frame constructed with a stiff material. The frame includes a central hollow portion. The electrode stack is disposed within the central hollow portion. The frame further includes a second portion of the frame that is porous or includes a gas diffusion membrane. The battery cell further includes an electrolyte disposed within the frame and in contact with the electrode stack. The battery cell further includes a functional material disposed within the battery cell and outside of the central hollow portion, the functional material being configured for absorbing the gas or the moisture. The second portion of the frame that is porous or includes a gas diffusion membrane enables the gas or the moisture to exit the central hollow portion and come into contact with the functional material while maintaining the electrolyte within the frame.

In some embodiments, the second portion of the frame includes an entirety of the frame.

In some embodiments, the battery cell is a pouch battery cell, a prismatic can battery cell, or a coin battery cell.

In some embodiments, the battery cell is a cylindrical can battery cell.

In some embodiments, the frame is cylindrical shaped, the central hollow portion is cylindrical shaped, and the electrode stack is spiral shaped.

In some embodiments, the frame includes a wall including a hollow area, and the functional material is disposed within the hollow area.

In some embodiments, the battery cell further includes an exterior case, and wherein the functional material is disposed between the frame and the exterior case.

In some embodiments, the frame is constructed with a polymer including polytetrafluoroethylene (PTFE), poly (1,1,2,2 tetrafluoroethylene), or a sulfonated tetrafluoroethylene-based fluoropolymer-copolymer.

In some embodiments, the frame is constructed with a metal including stainless steel, aluminum, or copper.

According to one alternative embodiment, a device is provided. The device includes a battery cell including an electrode stack including at least one pair of an anode and a cathode and a separator disposed between the anode and the cathode. Operation of the battery cell causes gas or moisture to form. The battery cell further includes a frame constructed with a stiff material. The frame includes a central hollow portion. The electrode stack is disposed within the central hollow portion. The frame further includes a second portion of the frame that is porous or includes a gas diffusion membrane. The battery cell further includes an electrolyte disposed within the frame and in contact with the electrode stack. The battery cell further includes a functional material disposed within the battery cell and outside of the central hollow portion, the functional material being configured for absorbing the gas or the moisture. The second portion of the frame that is porous or includes a gas diffusion membrane enables the gas or the moisture to exit the central hollow portion and come into contact with the functional material while maintaining the electrolyte within the frame.

In some embodiments, the device is a vehicle.

In some embodiments, the battery cell is a pouch battery cell, a prismatic can battery cell, a coin battery cell, or a cylindrical can battery cell.

In some embodiments, the frame includes a wall including a hollow area, and the functional material is disposed within the hollow area.

In some embodiments, the battery cell further includes an exterior case, and the functional material is disposed between the frame and the exterior case.

In some embodiments, the frame is constructed with a polymer including polytetrafluoroethylene (PTFE), poly (1,1,2,2 tetrafluoroethylene), or a sulfonated tetrafluoroethylene-based fluoropolymer-copolymer.

In some embodiments, the frame is constructed with a metal including stainless steel, aluminum, or copper.

According to one alternative embodiment, a method to create a battery cell is provided. The method includes assembling an electrode stack, disposing functional material within a hollow wall area of a frame, and inserting the electrode stack within a central hollow portion of the frame. The frame includes a second portion of the frame that is porous or includes a gas diffusion membrane. The method further includes inserting the frame and the electrode stack within an external case or envelope and disposing an electrolyte within the frame. The second portion of the frame enables gas to exit the frame while maintaining the electrolyte within the frame.

In some embodiments, the method further includes inserting a functional material configured for absorbing moisture or gas between the frame and the external case or envelope.

In some embodiments, the frame is constructed with a polymer including polytetrafluoroethylene (PTFE), poly (1,1,2,2 tetrafluoroethylene), or a sulfonated tetrafluoroethylene-based fluoropolymer-copolymer.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in cross-section an exemplary battery cell including an electrode stack, an exterior, a frame, and an electrolyte, in accordance with the present disclosure;

FIG. 2 schematically illustrates in perspective view an exemplary rectangular frame including hollow walls and functional material disposed therewithin, in accordance with the present disclosure;

FIG. 3 schematically illustrates in perspective view an alternative exemplary rectangular frame including hollow walls and functional material disposed therewithin, in accordance with the present disclosure;

FIG. 4A schematically illustrates in cross-section an exemplary disc shaped coin battery cell including an electrode stack, a stiff case, an anode cap, a frame, and an electrolyte, in accordance with the present disclosure;

FIG. 4B schematically illustrates in top view the disc shaped coin battery cell of FIG. 4A, in accordance with the present disclosure;

FIG. 5 schematically illustrates an exemplary device including a battery pack that includes a plurality of battery cells, in accordance with the present disclosure;

FIG. 6 is a flowchart illustrating a method for manufacturing the battery cell of FIG. 1 including the frame, in accordance with the present disclosure;

FIG. 7 schematically illustrates in perspective view an exemplary cylindrical shaped frame including hollow walls and functional material disposed therewithin, in accordance with the present disclosure;

FIG. 8 schematically illustrates in perspective view an exemplary prismatic can battery cell including an exterior case, a frame including a portion including porous material or a gas diffusion membrane, and functional material disposed between the frame and the exterior case, in accordance with the present disclosure;

FIG. 9 schematically illustrates an exemplary prismatic can battery cell including a prismatic can cell case and a frame including a portion including porous material or a gas diffusion membrane, in accordance with the present disclosure; and

FIG. 10 schematically illustrates an exemplary prismatic can battery cell including a prismatic can cell case and a frame, in accordance with the present disclosure.

### DETAILED DESCRIPTION

A battery system may include a plurality of battery cells. A battery cell may include an anode, a cathode, a separator, and an electrolyte. The separator may be constructed with a polymer, solid oxide materials, glass fiber, sulfide material, etc. The anode may include a first current collector and an anode electrode including an anode active material. The cathode may include a second current collector and a cathode electrode including a cathode active material.

A battery cell includes electrochemically reactive materials. The anode electrode includes anode active materials selected to electrochemically react with cathode active materials of the cathode electrode. There are also chemical reactions between the electrode materials and the electrolyte which may generate gas and/or liquid byproducts during battery storage and operation. Wherein the electrodes include porous particles, the chemical reactions occur at the electrolyte/electrode interfaces.

A battery cell is provided including a frame within the battery cell. The frame acts as a supporting structure that adds stiffness to battery cells to protect the electrodes when the cells are deformed. The frame further provides an isolated package space within the battery cell enabling functional materials that may absorb or otherwise neutralize gas and/or liquid generated within the battery cell. The frame may provide structural support for the battery cell and may include interior features configured for providing an enclosure with fixed dimensions to which battery cell components may be designed.

The frame additionally may include a central hollow portion and a gas permeable second portion including either a porous material or a gas permeable membrane. Battery cell components including the anode, the cathode, and the separator or an electrode stack may be disposed within the central hollow portion. The porous material or the gas permeable membrane enable gas and moisture to flow away from the electrodes, enabling the gas or moisture to exit the central hollow portion. The porous material or the gas permeable membrane may be configured for retaining an electrolyte within the central hollow portion of the frame while enabling the gas and other moisture to exit.

The frame may additionally include walls, and at least one of the walls of the frame may be hollow. In the alternative, a second hollow portion within the battery cell may be created between the frame and walls of a case or an enclosure of the battery cell. Within the hollow area of the wall or within the second hollow portion within the battery cell, a functional material may be disposed. The frame including the porous material or the gas permeable membrane may enable liquid and/or gas within the hollow central portion including the battery cell stack to flow out of the hollow central portion and into the hollow area of one of the walls of the frame or into the second hollow portion of the battery cell. Liquid and gas flowing through the portion of the frame including the porous material or the gas permeable membrane may flow from the central hollow portion containing the electrode stack, through the portion including the porous material or the gas permeable membrane, and flow into the hollow area of the wall or into the second hollow portion to be absorbed or neutralized by the functional material. In this way, gas and moisture originating within the central hollow portion may flow or be channeled to the functional material and be rendered a non-issue for the battery cell.

The disclosed frame including the gas permeable portion may be configured for use within a pouch battery cell, a prismatic can battery cell, a cylindrical can battery cell, or a coin cell format.

Dimensions of the frame, e.g. a height and a width, may depend upon dimensions of the battery cell and the electrode stack being contained within the frame. A thickness of the frame, wherein the electrode stack is planar or flat, may be slightly thicker than the electrode stack, may be slightly thinner than the electrode stack, or may be substantially a same thickness as the electrode stack. In one embodiment, an outer width of the frame may be in a range from 1 millimeter to 50 millimeters, and a corresponding width of a central hollow portion within the frame may be in a range from 0.5 millimeters to 49 millimeters.

A material of the frame may be a polymer such as polytetrafluoroethylene (PTFE), poly (1,1,2,2 tetrafluoroethylene), or a sulfonated tetrafluoroethylene-based fluoropolymer-copolymer. The material of the frame may alternatively be a metal such as stainless steel, aluminum, or copper.

Walls of the frame may be solid or hollow.

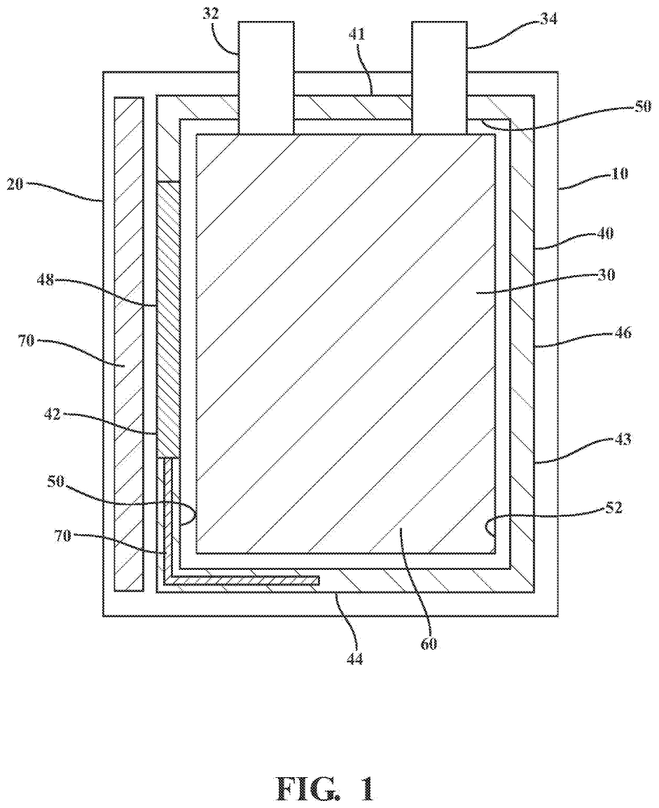

Referring now to the drawings, wherein like reference numbers refer to like features throughout the several views, FIG. 1 schematically illustrates in cross-section an exemplary battery cell 10 including an electrode stack 30, an exterior 20, a frame 40, and a electrolyte 60. The battery cell 10 may include a pouch battery cell, wherein the exterior 20 may be a flexible pouch exterior. The battery cell 10 may be a prismatic can battery cell, wherein the exterior 20 includes a stiff outer casing, which may include an exemplary rectangular shape. The battery cell 10 may be a cylindrical can battery cell, wherein the exterior 20 includes a stiff outer casing, which may include an exemplary cylindrical shape.

The electrode stack 30 is illustrated including a first current collector 32 and a second current collector 34, which each extend to an exterior of the battery cell 10. The exposed portions of the first current collector 32 and the second current collector 34 are provided as exemplary tabs or terminals for the battery cell 10. Battery cells include a wide variety of tab or terminal designs and configurations, and the disclosure is not intended to be limited to the examples provided herein. The first current collector 32 may be connected to an anode electrode including anode active materials. The second current collector 34 may be connected to a cathode electrode including cathode active materials. The electrode stack 30 includes one or more pairs of an anode and a cathode, with a separator disposed between each pair of anode and electrode. The shape and configuration of the electrode stack 30 may vary, for example, including a plurality of flat electrodes and flat separators, a wound electrode in a spiral shape, or other electrode configurations used in the art. The electrolyte 60 is in contact with the components of the electrode stack 30 and facilitates an electrochemical reaction therebetween.

The exemplary frame 40 is rectangular-shaped. The frame 40 may be configured in different shapes, depending upon a shape of the exterior 20 and a shape of the electrode stack 30. An internal wall surface 50 of the frame 40 defines a cavity or central hollow portion 52 within which the electrode stack 30 is disposed. Dimensions of the internal wall surface 50 may be configured for or designed to fit the electrode stack 30. In one embodiment, the internal wall surface 50 may be configured to be coincidental with a shape of the electrode stack 30. In another embodiment, the internal wall surface 50 may be configured to allow expansion and contraction of the electrode stack 30. In one embodiment, a gap between the electrode stack 30 and the frame 40 configured for permitting expansion and contraction of the electrode stack 30 may be less than 1 millimeter in width.

The frame 40 includes an exemplary top portion 41, a first side portion 42, a second side portion 43, and bottom portion 44. The frame 40 may be provided in a variety of shapes and sizes. The frame 40 includes stiff material 46 useful to provide structure within the battery cell 10. A portion 48 of the stiff material 46 is either porous or includes a gas diffusion membrane which enables gas to exit a central hollow portion 52 of the frame 40 while retaining the electrolyte 60 within the frame 40. Functional material 70 is illustrated within a hollow area of the first side portion 42 and the bottom portion 44. Gas and moisture within the central hollow portion 42 may flow through the portion 48 to be absorbed by the functional material 70. The functional material may include a material configured to absorb water and other liquids. The functional material may also or alternatively include gas absorbing materials such as an oxygen gas scrubbing material.

In the embodiment of FIG. 1, the portion 48 which is porous or includes a gas diffusion membrane includes less than an entirety of the frame 40. In another embodiment, the portion 48 may include an entirety of the frame 40. In the embodiment of FIG. 1, the portion 48 is located upon the first side portion 42. In another embodiment, the portion 48 may be located upon the top portion 41, the second side portion 43, and/or the bottom portion 44.

In some embodiments, the frame 40 may encapsulate the electrode stack, wherein the electrolyte 60 is entirely contained within the frame 40. In another embodiment, the frame 40 may surround the electrode stack in two dimensions, similar to a picture frame. In such an embodiment, the frame 40 may seal to an internal surface of an external case or envelope, such as the pouch exterior 20, to contain the electrolyte within the frame 40.

A width of a gap between the frame 40 and the pouch exterior 20 may be in a range from 1 millimeter to 50 millimeters.

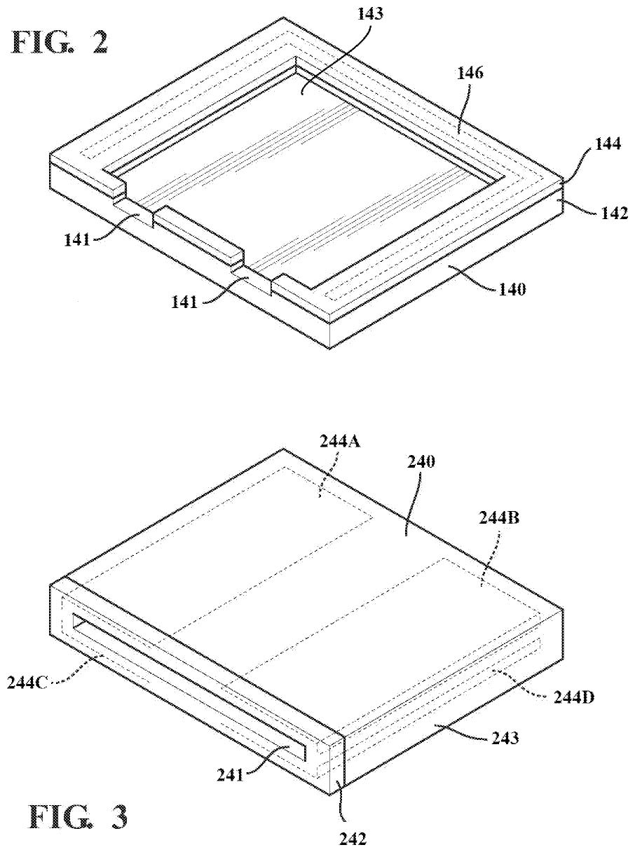

FIG. 2 schematically illustrates in perspective view an exemplary frame 140 including a portion 144 including a porous material or a gas diffusion membrane and a functional material 146 contained within a hollow portion of the frame 140. The frame 140 is configured for receiving and containing an electrode stack within a hollow central portion 143. The frame 140 includes two slots 141 formed to receive and fixture current conductors of the electrode stack to be placed within the hollow central portion 143. The frame 140 is hollow and includes the functional material 146 contained within the hollow portion of the frame 140. The frame 140 includes a stiff material 142 and the portion 144. The portion 144 may be in direct contact with or may provide a flow path for gas exiting the hollow central portion 143 to come into contact with the functional material 646.

FIG. 3 schematically illustrates in perspective view an additional exemplary frame 240 including a portion 242 including porous material or gas diffusion membrane and functional materials 244A, 244B, 244C, 244D contained within hollow portions of the frame 240. The frame 240 is illustrated including a hollow central portion 241, the gas permeable portion 242, and stiff material 243. The frame 240 is hollow and includes a first functional material 244A, a second functional material 244B, a third functional material 244C, and a fourth functional material 244D. The functional materials 244A, 244B, 244C, 244D include four exemplary pockets or packets of exemplary absorbent material disposed within the frame configured for neutralizing liquid and/or gases formed within the frame 240 and function as a jacket around the hollow central portion 241. The functional materials 244A, 244B, 244C, 244D come into contact with or are configured to receive a flow of gas or liquid through the portion 242. The frame 140 of FIG. 2 and the frame 240 of FIG. 3 may each be utilized within the exterior 20 of a corresponding battery cell 10 of FIG. 1.

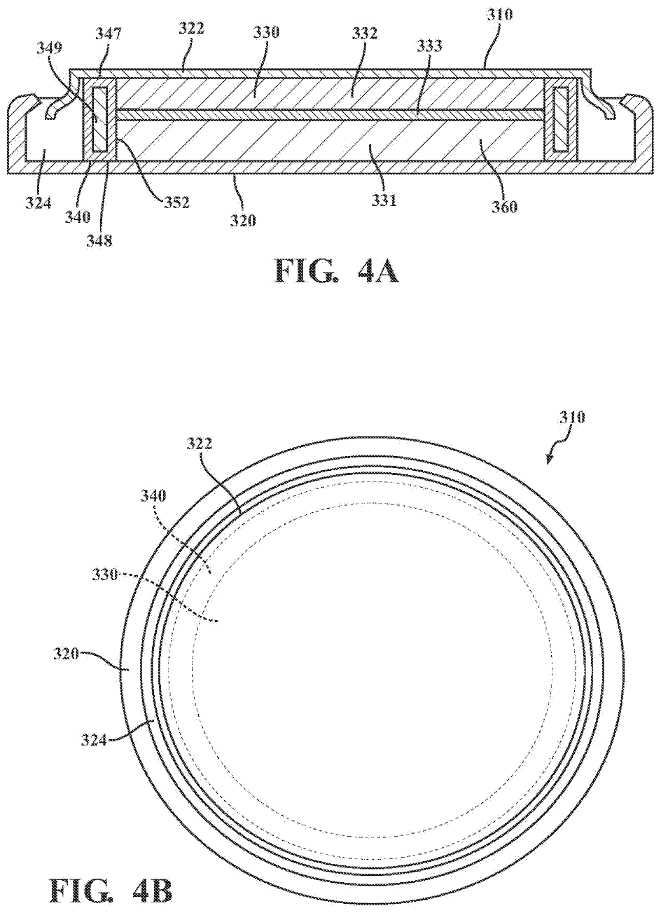

FIG. 4A schematically illustrates in cross-section an exemplary disc shaped coin battery cell 310 including an electrode stack 330, a stiff case 320, an anode cap 322, a frame 340, and an electrolyte 360. The stiff case 320 and the anode cap 322 may each be electrically conductive. The electrode stack 330 is illustrated including a cathode 331, an anode 332, and a separator 333. The electrolyte 360 is in contact with the components of the electrode stack 330 and facilitates electrochemical reactions therebetween. A gasket 324 is used to maintain physical separation and provide electrical insulation preventing a short circuit between the stiff case 320 and the anode cap 322.

The electrode stack 330 is disc shaped. The coin battery cell 310 is illustrated in side cross section. If the coin battery cell 310 were viewed in perspective view, the coin battery cell 310 would include a circular top and a circular bottom. The frame 340 is annular or ring-shaped and configured to receive the electrode stack 330 within a central hollow portion 352. The ring-shaped frame 340 surrounds the disc shaped electrode stack 330. The central hollow portion 352 may be configured to allow expansion and contraction of the electrode stack 330.

The frame 340 may be provided in a variety of shapes and sizes. The frame 340 includes a material the provides stiffness or structure within the battery cell 310. A portion 348 of the frame 340 is either porous or includes a gas diffusion membrane which enables gas to exit from the central hollow portion 352 of the frame 340 while retaining the electrolyte 360 within the frame 340. In the embodiment of FIG. 1, the portion 348 in the embodiment of FIG. 4A which is porous or includes a gas diffusion membrane includes an entirety of the frame 340. In another embodiment, the portion 348 may include a top surface 347 of the frame 340 which may be porous or include a gas diffusion membrane. The frame 340 may be solid or hollow. In the embodiment of FIG. 4, the frame 340 is hollow and includes a functional material 349 within the hollow portion. Gas and moisture within the central hollow portion 352 flow through the frame 340 to be absorbed by the functional material 349 within the hollow walls of the frame 340.

FIG. 4B schematically illustrates the coin battery cell 310 in a top view. The battery cell 310 is illustrated including the electrode stack 330, the stiff case 320, the anode cap 322, the frame 340, and the gasket 324.

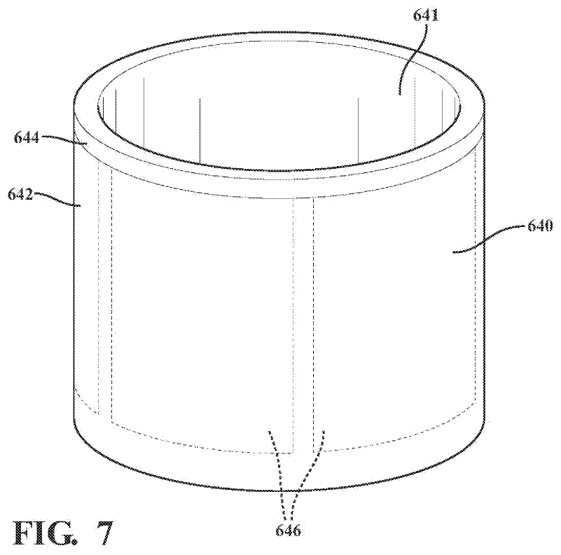

FIG. 7 schematically illustrates in perspective view an exemplary cylindrical shaped frame 640 including hollow walls and functional material 646 disposed therewithin. The cylindrical shaped frame 640 is configured for use within a cylindrical can battery cell. The frame 640 may include stiff material 642. The frame 640 may include portion 644 including porous material or a gas diffusion membrane, wherein portion 644 is configured for enabling gas and/or moisture to flow from a central hollow portion 641 of the frame 640 to contact and be absorbed by the functional material 646 within the walls of the frame 640.

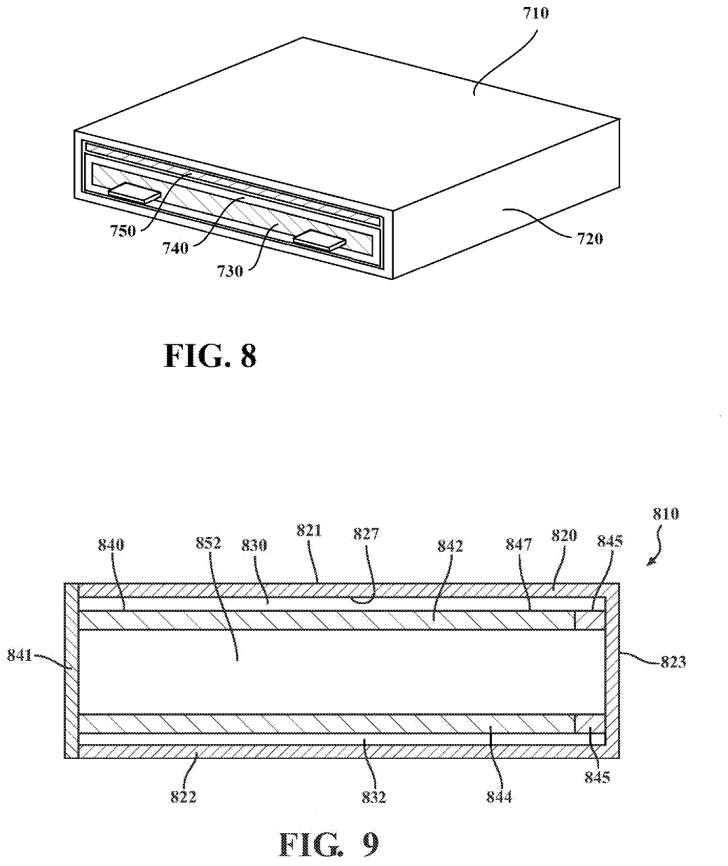

FIG. 8 schematically illustrates in perspective view an exemplary prismatic can battery cell 710 including an exterior case 720, an electrode stack 730, a frame 740 including a portion including porous material or a gas diffusion membrane, and functional material 750. The frame 740 encases the electrode stack 730. An electrolyte contained therewithin is in contact with the electrode stack 730. The frame 740 retains the electrolyte therewithin, while the frame 740 enables gas and/or moisture to exit the frame 740 and come into contact with the functional material 750. The functional material 750 is disposed between the frame 740 and the exterior case 720.

FIG. 9 schematically illustrates an exemplary prismatic can battery cell 810 including a prismatic can cell case 820 and a frame 840 including a portion 845 including porous material or a gas diffusion membrane. The prismatic can cell case 820 includes a first wall 821, a second wall 822, and a third wall 823. The prismatic can cell case 820 may include a rectangular enclosure with an open end. The frame 840 includes a panel 841 configured for completing the rectangular enclosure of the prismatic can cell case 820, such that the walls 821, 822, 823 of the prismatic can cell case 820 and the panel 841 create an internal volume of the prismatic can cell case 820. The frame 840 further includes a first wall 842 and a second wall 844 which, in combination with the prismatic can cell case 820, collectively create a hollow central portion 852 useful to contain a battery cell stack. Each of the walls 842, 844 are configured for sealing against internal walls of the prismatic can cell case 820 such that by-product liquids and gases are initially contained within the hollow central portion 852. The frame 840 includes the portions 845 including porous material or a gas diffusion membrane, such that a liquid and/or a gas may flow from the hollow central portion 852 to a second hollow portion 830 which exists between a surface 827 of the wall 821 and a surface 847 of the wall 842 and a third hollow portion 832 which exists between the wall 822 and the wall 844. The second hollow portion 830 may include a functional material in accordance with the present disclosure. Liquid and/or gas that exist within the hollow central portion 852 may flow through the portions 845 to be absorbed, neutralized, or otherwise mitigated by functional material within the second hollow portion 830.

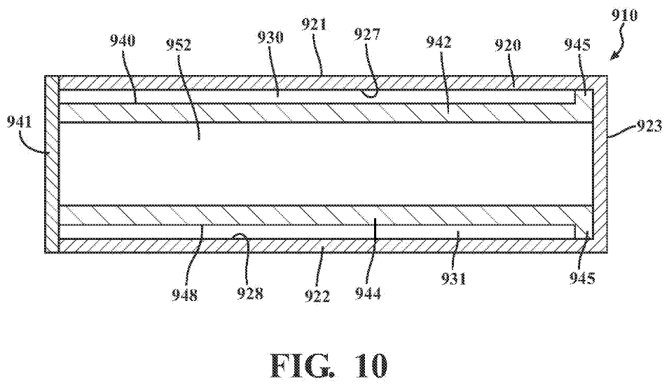

FIG. 10 schematically illustrates an exemplary prismatic can battery cell 910 including a prismatic can cell case 920 and a frame 940. Walls 942 and 944 of the frame 940 may include porous material. The prismatic can cell case 920 includes a first wall 921, a second wall 922, and a third wall 923. The prismatic can cell case 920 may include a rectangular enclosure with an open end. The frame 940 includes a panel 941 configured for completing the rectangular enclosure of the prismatic can cell case 920, such that the walls 921, 922, 923 of the prismatic can cell case 920 and the panel 941 create an internal volume of the prismatic can cell case 920. The walls 942, 944 and the prismatic can cell case 920 collectively create a hollow central portion 952 useful to contain a battery cell stack. Each of the walls 942, 944 are configured for sealing against internal walls of the prismatic can cell case 920 such that by-product liquids and gases are initially contained within the hollow central portion 952. The frame 940 includes spacing features 945 configured to create space between a surface 927 of the wall 921 and a surface 947 of the wall 942 and between a surface 928 of the wall 922 and a surface 948 of the wall 944, respectively. Space between the surface 927 and the surface 947 defines a second hollow portion 930, and space between the surface 928 and the surface 948 defines a third hollow portion 931. The second hollow portion 930 and/or the third hollow portion 931 may each include a functional material in accordance with the present disclosure. Liquid and/or gas that exist within the hollow central portion 952 may flow through the porous walls 942, 944 to be absorbed, neutralized, or otherwise mitigated by functional material within the second hollow portion 930 and/or the third hollow portion 931.

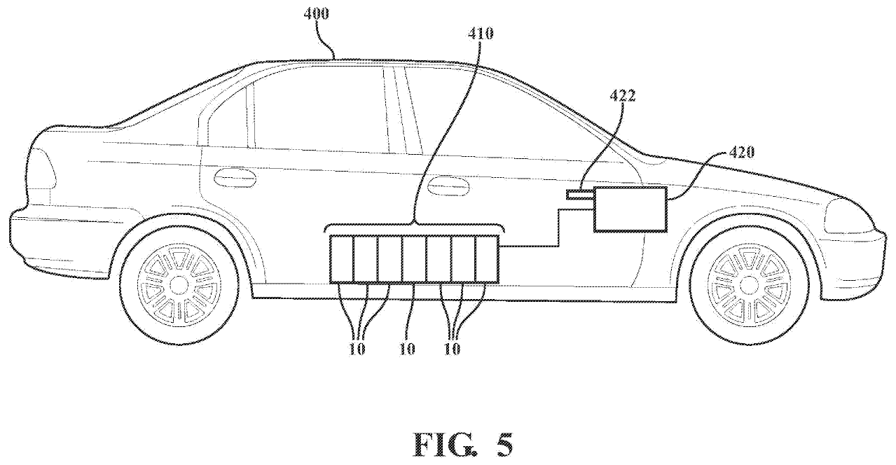

The battery cells 10 of FIG. 1, 310 of FIG. 4A, 710 of FIG. 8, and other battery cells described herein may be utilized in a wide range of applications and powertrains. FIG. 5 schematically illustrates an exemplary device 400, e.g., a battery electric vehicle (BEV), including a battery pack 410 that includes a plurality of battery cells 10. The plurality of battery cells 10 may be connected in various combinations, for example, with a portion being connected in parallel and a portion being connected in series, to achieve goals of supplying electrical energy at a desired voltage. The battery pack 410 is illustrated as electrically connected to a motor generator unit 420 useful to produce motive force to the device 400. The motor generator unit 420 may include an output component 422, for example, an output shaft, which provides mechanical energy useful to provide the motive force to the device 400. A number of variations to device 400 are envisioned, for example, including a powertrain, a boat, an airplane, or an electrical vertical takeoff and landing aircraft (eVTOL), and the disclosure is not intended to be limited to the examples provided.

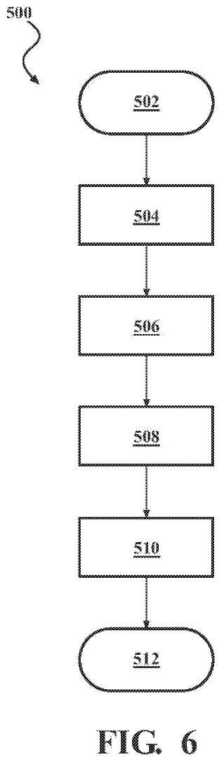

FIG. 6 is a flowchart illustrating a method 500 for manufacturing the battery cell 10 of FIG. 1 including the frame 40. While the method 500 is described in relation to the battery cell 10 of FIG. 1, the method 500 may be similarly be applied in relation to other similar battery cell configurations. The method 500 starts at step 502. At step 504, an electrode stack 30 is assembled. At step 506, functional material 70 is disposed within a hollow area of a wall of a frame 40, and a portion 48 including porous material or a gas diffusion membrane is installed to the frame 40. At step 508, the electrode stack 30 is inserted within a frame 40, and the frame 40 including the electrode stack 30 is inserted within an exterior 20. At step 510, an electrolyte 60 is disposed within the frame 40, and the battery cell 10 is then sealed. The sealed battery cell 10 is ready to be utilized within a wide variety of devices and applications. At step 512, the method 500 ends. The method 500 is an exemplary method or process to manufacture the disclosed battery cell 10. A number of additional and/or alternative method steps are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A battery cell, comprising:
an electrode stack including at least one pair of an anode and a cathode and a separator disposed between the anode and the cathode, wherein operation of the battery cell causes gas or moisture to form;
a frame constructed with a stiff material, the frame including:
a central hollow portion, wherein the electrode stack is disposed within the central hollow portion; and
a second portion of the frame that is porous or includes a gas diffusion membrane;
an electrolyte disposed within the frame and in contact with the electrode stack; and
a functional material disposed within the battery cell and outside of the central hollow portion, the functional material being configured for absorbing the gas or the moisture; and
wherein the second portion of the frame that is porous or includes a gas diffusion membrane enables the gas or the moisture to exit the central hollow portion and come into contact with the functional material while maintaining the electrolyte within the frame.

2. The battery cell of claim 1, wherein the second portion of the frame includes an entirety of the frame.

3. The battery cell of claim 1, wherein the battery cell is a pouch battery cell, a prismatic can battery cell, or a coin battery cell.

4. The battery cell of claim 1, wherein the battery cell is a cylindrical can battery cell.

5. The battery cell of claim 4, wherein the frame is cylindrical shaped;
wherein the central hollow portion is cylindrical shaped; and
wherein the electrode stack is spiral shaped.

6. The battery cell of claim 1, wherein the frame includes a wall including a hollow area; and
wherein the functional material is disposed within the hollow area.

7. The battery cell of claim 1, wherein the battery cell further includes an exterior case; and
wherein the functional material is disposed between the frame and the exterior case.

8. The battery cell of claim 1, wherein the frame is constructed with a polymer including polytetrafluoroethylene (PTFE), poly (1,1,2,2 tetrafluoroethylene), or a sulfonated tetrafluoroethylene-based fluoropolymer-copolymer.

9. The battery cell of claim 1, wherein the frame is constructed with a metal including stainless steel, aluminum, or copper.

10. A device, comprising:
a battery cell including:
an electrode stack including at least one pair of an anode and a cathode and a separator disposed between the anode and the cathode, wherein operation of the battery cell causes gas or moisture to form;
a frame constructed with a stiff material, the frame including:
a central hollow portion, wherein the electrode stack is disposed within the central hollow portion; and
a second portion of the frame that is porous or includes a gas diffusion membrane;
an electrolyte disposed within the frame and in contact with the electrode stack; and
a functional material disposed within the battery cell and outside of the central hollow portion, the functional material being configured for absorbing the gas or the moisture; and
wherein the second portion of the frame that is porous or includes a gas diffusion membrane enables the gas or the moisture to exit the central hollow portion and come into contact with the functional material while maintaining the electrolyte within the frame.

11. The device of claim 10, wherein the device is a vehicle.

12. The device of claim 10, wherein the battery cell is a pouch battery cell, a prismatic can battery cell, a coin battery cell, or a cylindrical can battery cell.

13. The device of claim 10, wherein the frame includes a wall including a hollow area; and
wherein the functional material is disposed within the hollow area.

14. The device of claim 10, wherein the battery cell further includes an exterior case; and
wherein the functional material is disposed between the frame and the exterior case.

15. The device of claim 10, wherein the frame is constructed with a polymer including polytetrafluoroethylene (PTFE), poly (1,1,2,2 tetrafluoroethylene), or a sulfonated tetrafluoroethylene-based fluoropolymer-copolymer.

16. The device of claim 10, wherein the frame is constructed with a metal including stainless steel, aluminum, or copper.

17. A method to create a battery cell, the method comprising:
assembling an electrode stack;
disposing functional material within a hollow wall area of a frame;
inserting the electrode stack within a central hollow portion of the frame, wherein the frame includes a second portion of the frame that is porous or includes a gas diffusion membrane;
inserting the frame and the electrode stack within an external case or envelope; and
disposing an electrolyte within the frame; and
wherein the second portion of the frame enables gas to exit the frame while maintaining the electrolyte within the frame.

18. The method of claim 17, further comprising:
inserting a functional material configured for absorbing moisture or gas between the frame and the external case or envelope.

19. The method of claim 17, wherein the frame is constructed with a polymer including polytetrafluoroethylene (PTFE), poly (1,1,2,2 tetrafluoroethylene), or a sulfonated tetrafluoroethylene-based fluoropolymer-copolymer.
